(19) United States
(12) Patent Application Publication
(10) Pub. No.: US 2026/0259179 A1
(43) Pub. Date: Sep. 3, 2026

(54) ULTRASONIC INSTRUMENT FOR MATERIAL CHARACTERIZATION

(71) Applicants: Erik Maas, Phoenix, AZ (US); Leila Jannesari Ladani, Mesa, AZ (US)

(72) Inventors: Erik Maas, Phoenix, AZ (US); Leila Jannesari Ladani, Mesa, AZ (US)

(73) Assignee: Arizona Board of Regents on behalf of Arizona State University, Scottsdale, AZ (US)

(21) Appl. No.: 19/038,097

(22) Filed: Jan. 27, 2025

Related U.S. Application Data
(60) Provisional application No. 63/627,336, filed on Jan. 31, 2024.

(51) Int. Cl. G01N 29/30; G01N 29/22

(52) U.S. Cl. CPC G01N 29/30; G01N 29/226

(57) ABSTRACT

An ultrasonic measurement device comprising a first frame portion with an inner side and an outer side, a second frame portion with an inner side and an outer side, wherein the first frame portion and the second frame portion are movably connected, wherein the first frame portion is configured to move in parallel orientation relative to the second frame portion, a first ultrasonic transducer positioned on the inner side of the first frame portion, and a second ultrasonic transducer positioned on the inner side of the second frame portion opposite the first transducer.

### CROSS-REFERENCE TO RELATED APPLICATIONS

This application claims priority to U.S. Provisional Patent Application No. 63/627,336 filed Jan. 31, 2024, the contents of which are incorporated by reference herein in its entirety.

### BACKGROUND OF THE INVENTION

Ultrasound imaging is a common tool for material characterization and flaw detection in soft tissues. It can provide quantitative, clinically relevant diagnostic information or be used in the lab to evaluate tissues for bioengineering purposes. Ultrasound imaging requires direct contact of the probe to the tissue to minimize excess attenuation and backscatter. However, the contact force applied by the ultrasound probe to the tissue can vary widely throughout the measurement process and between separate measurements, decreasing result accuracy. Excessive force can also cause increased strain to the sample and potentially damage the tissue. Measuring the contact force during a scan can therefore increase the repeatability and reliability of ultrasound measurements by ensuring a constant contact force, while also preventing excessive strain or damage to the sample being tested.

Thus, there is a need in the art for an ultrasound device with force-sensing capabilities for the material characterization of biological tissues. The present invention meets this need.

### SUMMARY OF THE INVENTION

Some embodiments of the invention disclosed herein are set forth below, and any combination of these embodiments (or portions thereof) may be made to define another embodiment.

In one aspect, the present invention relates to an ultrasonic measurement device comprising a first frame portion with an inner side and an outer side, a second frame portion with an inner side and an outer side, wherein the first frame portion and the second frame portion are movably connected, wherein the first frame portion is configured to move in a parallel orientation relative to the second frame portion, a first ultrasonic transducer positioned on the inner side of the first frame portion, and a second ultrasonic transducer positioned on the inner side of the second frame portion opposite the first transducer.

In some embodiments, the first and second frame portions are movably connected via a pivot, a hinge, screw jack mechanism, or a parallel linkage mechanism. In some embodiments, the first ultrasonic transducer is configured to emit or receive an ultrasonic signal. In some embodiments, the second ultrasonic transducer is configured to emit or receive an ultrasonic signal.

In some embodiments, the ultrasonic measurement device further comprises a force sensor connected to at least one of the first and second frame portions and configured to measure a clamping force exerted between the first and second ultrasonic transducers. In some embodiments, the force sensor comprises at least one of a load cell and a force sensing resistor. In some embodiments, the ultrasonic measurement device further comprises a displacement sensor connected to at least one of the first and second frame portions and configured to measure a spacing between the first and second ultrasonic transducers. In some embodiments, the displacement sensor comprises a linear potentiometer. In some embodiments, the ultrasonic measurement device is configured as a handheld device.

In some embodiments, the first ultrasonic transducer is positioned at a first end of the first frame portion, and the second ultrasonic transducer is positioned at a first end of the second frame portion. In some embodiments, the first frame portion comprises a first handle portion at a second end, and the second frame portion comprises a second handle portion at a second end. In some embodiments, a force applied to the first and second handle portions causes the first ends of the first and second frame portions to separate.

In some embodiments, the ultrasonic measurement device further comprises a biasing mechanism to bias the device closed. In some embodiments, the biasing mechanism comprises one or more tension springs mounted between the first and second frame portions at locations proximate to the linkage point.

In some embodiments, the ultrasonic measurement device is configured to apply a force in the range of 0 to 100 grams to a sample. In some embodiments, the ultrasonic measurement device is configured to have a spacing of 0 to 150 mm between the first and second ultrasonic transducers.

In some embodiments, the ultrasonic measurement device further comprises a computing system communicatively connected to the device, comprising a processor and a non-transitory computer-readable medium with instructions stored thereon, which when executed by the processor, perform steps comprising measuring the displacement between the first and second ultrasonic transducers, measuring a force applied to the sample via the force sensor, performing an ultrasound measurement on the sample, and displaying the results of the displacement, force, and ultrasound measurement.

In another aspect, the present invention relates to an ultrasonic measurement method, comprising providing the ultrasonic measurement device, positioning a sample between the first and second ultrasonic transducers, measuring the displacement between the first and second ultrasonic transducers, measuring a force applied to the sample via the force sensor, performing an ultrasound measurement on the sample, and displaying the results of the displacement, force, and ultrasound measurement.

In some embodiments, the ultrasonic measurement method further comprises applying a squeezing force to the first and second handle portions and removing the squeezing force when the sample is positioned between the first and second ultrasonic transducers. In some embodiments, the ultrasonic measurement method further comprises calibrating a displacement between the first and second ultrasonic transducers and calibrating a force between the first and second ultrasonic transducers.

### BRIEF DESCRIPTION OF THE DRAWINGS

The following detailed description of embodiments of the invention will be better understood when read in conjunction with the appended drawings. It should be understood, however, that the invention is not limited to the precise arrangements and instrumentalities of the embodiments shown in the drawings.

FIG. 1 depicts a schematic of an exemplary embodiment of an ultrasonic measurement device.

FIGS. 2A-2B depict an exemplary embodiment of an ultrasonic measurement device. FIG. 2A depicts a right-side perspective view of an exemplary ultrasonic measurement device in a closed state. FIG. 2B depicts a right-side perspective view of an exemplary ultrasonic measurement device in an open state.

FIGS. 3A-3B depict an exemplary embodiment of an ultrasonic measurement device. FIG. 3A depicts a left-side perspective view of an exemplary ultrasonic measurement device in a closed state. FIG. 3B depicts a left-side perspective view of an exemplary ultrasonic measurement device in an open state.

FIGS. 4A-4F depict schematic views of an exemplary ultrasonic measurement device. FIG. 4A depicts a left-side perspective view. FIG. 4B depicts a right-side perspective view. FIG. 4C depicts a top-down perspective view. FIG. 4D depicts a front perspective view. FIG. 4E depicts a computerized model of an exemplary ultrasonic measurement device. FIG. 4F depicts a cross-sectional view.

FIGS. 5A-5D depict an exemplary embodiment of the ultrasonic measurement device. FIG. 5A depicts a front-view of the exemplary embodiment of the ultrasonic measurement device. FIGS. 5B and 5C depict a right perspective view of the exemplary embodiment of the ultrasonic measurement device.

FIGS. 6A-6D depict the results from experiments determining the effect of clamping force on peak density. FIG. 6A depicts a graph of peak density vs. clamping force measurement in a 13.1 mm thick tissue sample. FIG. 6B depicts a graph of peak density vs. clamping force measurement in a 9.7 mm thick tissue sample. FIG. 6C depicts a graph of peak density vs. clamping force measurement in a 7.6 mm thick tissue sample. FIG. 6D depicts a graph of peak density vs. clamping force measurement in a 4.0 mm thick tissue sample.

FIGS. 7A-7D depict the results from experiments to determine the effect of clamping force on the thickness of tissue samples when the clamping force is varied. FIG. 7A depicts a graph of thickness vs. clamping force of a 13.1 mm thick tissue sample. FIG. 7B depicts a graph of thickness vs. clamping force of a 9.7 mm thick tissue sample. FIG. 7C depicts a graph of thickness vs. clamping force of a 7.6 mm thick tissue sample. FIG. 7D depicts a graph of thickness vs. clamping force of a 4.0 mm thick tissue sample.

FIGS. 8A-8C depict the results from experiments to determine the effect of sample thickness on peak density. FIG. 8A and FIG. 8B depict graphs showing the effect of sample thickness on broad-band peak density in various tissue samples. FIG. 8C depicts a graph showing the effect of sample thickness on narrowband peak density in various tissue samples.

FIG. 9 depicts an exemplary computing environment in which aspects of the present invention may be practiced.

### DETAILED DESCRIPTION

The following discussion omits or only briefly describes conventional features of ultrasound devices that are apparent to those skilled in the art. Those of ordinary skill in the pertinent arts may thus recognize that other elements may be desirable and/or necessary to implement the devices, systems, and/or methods described herein. It is noted that various embodiments are described in detail with reference to the drawings. Reference to these various embodiments does not limit the scope of the claims attached hereto. Additionally, any embodiments set forth in this specification are intended to be non-limiting and merely set forth some of the many possible implementations for the appended claims. Further, particular features described herein can be used in combination with other described features in each of the various possible combinations and permutations. As such, it is understood that this detailed description is exemplary and explanatory only and is not restrictive of the broad inventive concepts upon which the embodiments disclosed herein are based.

Unless otherwise specifically defined herein, all terms are to be given their broadest reasonable interpretation. This includes meanings implied from the specification as well as meanings understood by those skilled in the art and/or as defined in dictionaries, treatises, etc.

It is noted that, as used in this specification and the appended claims, the singular forms “a,” “an,” and “the” include plural referents unless otherwise specified. The term “includes” and/or “including,” when used in this specification, specify the presence of stated features, elements, and/or components, but do not preclude the presence or addition of one or more other features, steps, operations, elements, components, and/or groups thereof.

Relative terms such as “horizontal,” “vertical,” “up,” “down,” “top,” and “bottom” as well as derivatives thereof (e.g., “horizontally,” “downwardly,” “upwardly,” etc.) should be construed to refer to the orientation as then-described or as shown in the drawing figure under discussion. These relative terms are for convenience of description and normally are not intended to require a particular orientation in actuality. Terms including “inwardly” versus “outwardly,” “longitudinal” versus “lateral,” and the like are to be interpreted relative to one another or relative to an axis of elongation, or an axis or center of rotation, as appropriate. Terms concerning attachments, coupling and the like, such as “connected” and “interconnected,” refer to a relationship wherein structures are secured or attached to one another either directly or indirectly through intervening structures, as well as both movable or rigid attachments or relationships, unless expressly described otherwise. The phrases “operatively” or “operably connected” indicates such an attachment, coupling, or connection that allows the pertinent structures to operate as intended by virtue of that relationship.

Reference throughout the specification to “one embodiment,” “an embodiment,” or “some embodiments” means that a particular feature, structure, or characteristic described in connection with at least one example of the subject matter is included in at least one example of the subject matter disclosed. Thus, the appearance of the phrases “in one embodiment,” “in an embodiment,” or “in some embodiments” in various places throughout the specification is not necessarily referring to the same embodiment. Further, the particular features, structures, or characteristics of “one embodiment,” “an embodiment,” or “some embodiments” may be combined in any suitable manner with each other to form additional embodiments of such combinations. It is intended that embodiments of the disclosed subject matter cover modifications and variations thereof. Terms such as “first,” “second,” “third,” etc., merely identify one of a number of portions, components, steps, operations, functions, and/or points of reference as disclosed herein, and likewise to not necessarily limit embodiments of the present disclosure to any particular configuration or orientation.

Moreover, throughout this disclosure, various aspects can be presented in a range format. It should be understood that the description in range format is merely for convenience and brevity and should not be construed as an inflexible limitation on the scope of the disclosure. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6, etc., as well as individual numbers within that range, for example, 1, 2, 2.7, 3, 4, 5, 5.3, 6, and any whole and partial increments therebetween. This applies regardless of the breadth of the range. As used herein, the term “about” in reference to a measurable value, such as an amount, a temporal duration, and the like, is meant to encompass the specified value variations of plus or minus 20%, plus or minus 10%, plus or minus 5%, plus or minus 1%, and plus or minus 0.1% of the specified value, as such variations are appropriate and fit within the confines of a functional system.

The terms “proximal,” “distal,” “anterior,” “posterior,” “medial,” “lateral,” “superior,” and “inferior” are defined by their standard usage indicating a directional term of reference. For example, “proximal” refers to a position that is situated nearer to the center of a body or point of attachment or interest. In another example, “anterior” refers to the front of a body or structure, while “posterior” refers to the rear of a body or structure, in relation to a relative viewpoint. In another example, “medial” refers to the direction towards the midline of a body or structure, and “lateral” refers to the direction away from the midline of a body or structure. In some embodiments, “lateral” or “laterally” may refer to any sideways direction. In another example, “superior” refers to the top of a body or structure, while “inferior” refers to the bottom of a body or structure. It should be understood, however, that the directional term of reference may be interpreted within the context of a specific body or structure, such that a directional term referring to a location in the context of the reference body or structure may remain consistent as the orientation of the body or structure changes.

The terms “patient,” “subject,” “individual,” and the like are used interchangeably herein and refer to any human, animal, or other living organism amenable to the systems, devices, and methods described herein.

Described herein is an ultrasonic measurement device for material characterization and flaw detection in biological tissues. In some embodiments, the ultrasonic measurement device uses a pitch-catch technique for ultrasonic measurement and comprises two ultrasonic transducers between which a sample is placed. In some embodiments, the ultrasonic measurement device also measures the clamping force exerted on the sample and the thickness of the sample for use in interpreting the ultrasonic signal response and improving the reliability and repeatability of the measurement. The measurement of the clamping force also may avoid excessive strain in the sample and prevent damage to the sample.

Also described herein is an ultrasonic measurement method, comprising the steps of a) providing an ultrasonic measurement device, b) positioning a sample between the first and second ultrasonic transducers, c) measuring the displacement between the first and second ultrasonic transducers, d) measuring a force applied to the sample via the force sensor, e) performing an ultrasound measurement on the sample, and f) displaying the results of the displacement, force, and ultrasound measurement.

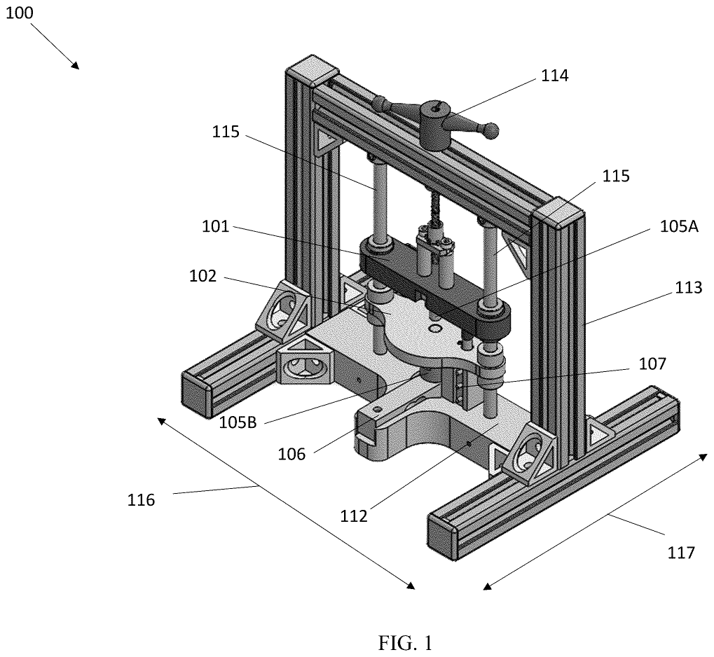

Referring now to FIG. 1, an exemplary ultrasonic measurement device 100 is depicted. In some embodiments, the ultrasonic measurement device 100 comprises a first frame portion 101 with an inner side and an outer side and a second frame portion 102 with an inner side and an outer side, where the first frame portion 101 is movably connected to and configured to move in a parallel orientation relative to the second frame portion 102. In some embodiments, the device 100 includes a first ultrasonic transducer 105A positioned on the inner side of the first frame portion 101, and a second ultrasonic transducer 105B positioned on the inner side of the second frame portion 102 opposite the first transducer 105A.

In some embodiments, the device 100 further comprises a force sensor 106 and a displacement sensor 107 positioned on the inner or outer side of the first frame portion 101 or the second frame portion 102. In some embodiments, the first ultrasonic transducer 105A may be positioned at any location on the inner surface of the first frame portion 101. In some embodiments, the second ultrasonic transducer 105B may be positioned at any location on the inner surface of the second frame portion 102, such that the second ultrasonic transducer 105B is opposite to the first ultrasonic transducer 105A. The arrangement of ultrasonic transducers 105 is configured such that ultrasonic measurements can be performed on a sample placed between the first and the second ultrasonic transducers 105 such that the sample is in direct contact with both the first and second ultrasonic transducers when device 100 is in a closed state. In some embodiments, the first ultrasonic transducer 105A is configured to emit an ultrasound signal or receive an ultrasound signal passed through a sample. In some embodiments, the second ultrasonic transducer 105B is configured to receive an ultrasound signal passed through a sample or emit an ultrasound signal.

In some embodiments, the frame portions 101 and 102 may have any suitable shape including, but not limited to, cuboidal, cylindrical, hemicylindrical, L-shaped, tapered, conical, or any combinations thereof. In some embodiments, the first frame portion 101 and the second frame portion 102 may be of the same shape or have different shapes. In some embodiments, the first frame portion 101 and the second frame portion 102 may have different lengths. In some embodiments, the first frame portion 101 and the second frame portion 102 may be made of any suitable rigid material, including but not limited to plastics, metals, metal alloys, polyethylene, thermoplastic polyurethane (TPU), polylactic acid (PLA), polyether ether ketone (PEEK), polyvinyl chloride (PVC) and the like. In some embodiments, the first frame portion 101 and second frame portion 102 may be 3D printed.

In some embodiments, and referring to FIG. 1, device 100 further comprises a base 112 and a support frame 113 connected in a perpendicular orientation relative to each other. In some embodiments, the first frame portion 101 is attached to the top side of support frame 113 and the second frame portion 102 is attached to the base 112 using supports 115. In some embodiments, the first and second frame portions 101, 102 are movably connected by a linkage mechanism such that the frame portions 101 and 102 move in a parallel orientation relative to each other. In some embodiments, the linkage mechanism may be any suitable linkage mechanism that allows the frame portions 101 and 102 to move in a parallel orientation relative to each other including, but not limited to, a hinge mechanism, a pivot mechanism, a screw jack mechanism, or a parallel linkage mechanism.

In some embodiments, the linkage mechanism is a screw jack mechanism configured to translate an applied rotational motion into the linear motion of the first frame portion 101 and the second frame portion 102. In some embodiments, one or more knobs 114 are attached to at least one of, base 112, frame 113, first frame portion 101 and second frame portion 102. In some embodiments, the one or more knobs 114 are configured to drive one or more lead screws along supports 115, thereby varying the distance between the inner surfaces of the first frame portion 101 and the second frame portion 102 In some embodiments, the lead screw is driven by a stepper motor. In some embodiments, at least one of first frame portion 101 and second frame portion 102 are configured to be movable. In some embodiments, the device 100 is in an open state when there is an air gap between ultrasonic transducers 105 and in a closed state when ultrasonic transducers 105 are in direct contact with a sample. In some embodiments, when the device 100 is in a closed state, a clamping force is exerted on a sample positioned between the first and second ultrasonic transducers 105A, 105B. In some embodiments, the lead screw is configured to be driven by a stepper motor communicatively connected to at least one of a displacement sensor, a force sensor, the first and second ultrasonic transducers 105A, 105B, and any suitable computing environment (e.g. computer 1200). In some embodiments, the stepper motor may be configured to automatically drive the frame portions 101 and 102 to a specified distance from each other, or to apply a specified clamping force to the sample. In some embodiments, the motor is communicatively connected to any suitable controls including, but not limited to buttons, knobs, and switches. In some embodiments, the controls may be located at any position on the inner or outer surface of at least one of the first and second frame portions 101, 102.

In some embodiments, the device 100 may have a length 116 of between about 10 to about 100 cm, between about 20 to about 90 cm, between about 30 to about 80 cm, between about 40 to about 70 inches, between about 45 to about 65 cm, between about 30 to about 60 cm, between about 35 to 55 cm, about 36 cm, about 37 cm, about 38 cm, about 39 cm, about 40 cm, about 41 cm, about 42 cm, about 43 cm, about 44 cm, about 45 cm, about 46 cm, about 47 cm, about 48 cm, about 49 cm, about 50 cm, about 51 cm, about 52 cm, about 53 cm, about 54 cm, or about 55 cm.

In some embodiments, the device 100 may have a width 117 of between about 10 to about 100 cm, between about 20 to about 90 cm, between about 30 to about 80 cm, between about 40 to about 70 inches, between about 45 to about 65 cm, between about 30 to about 60 cm, between about 35 to 55 cm, about 36 cm, about 37 cm, about 38 cm, about 39 cm, about 40 cm, about 41 cm, about 42 cm, about 43 cm, about 44 cm, about 45 cm, about 46 cm, about 47 cm, about 48 cm, about 49 cm, about 50 cm, about 51 cm, about 52 cm, about 53 cm, about 54 cm, or about 55 cm.

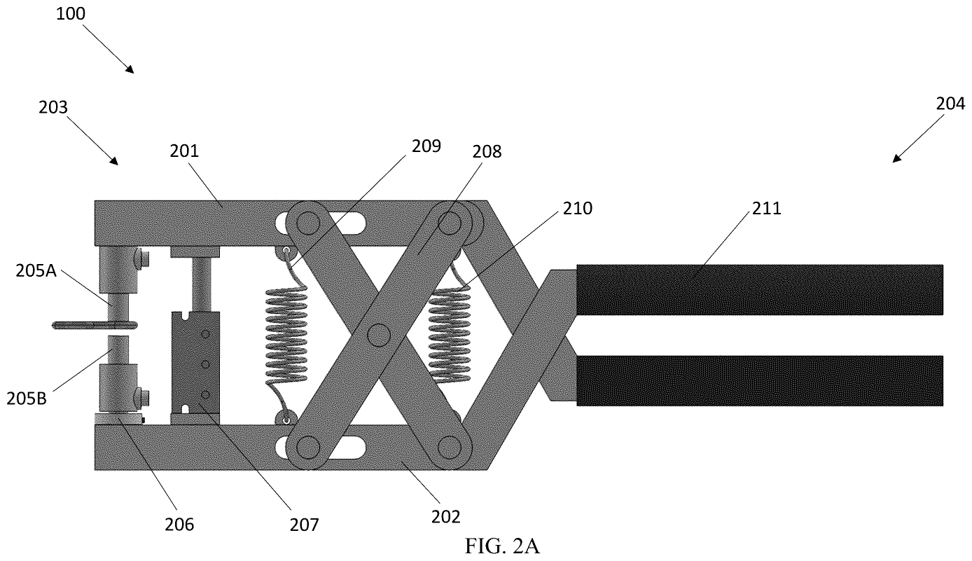

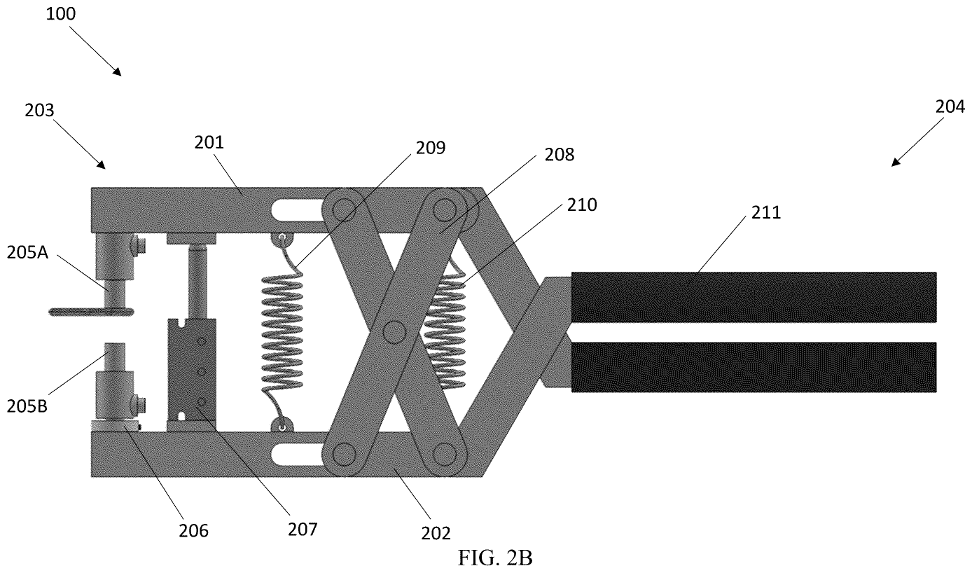

In some embodiments, device 100 is configured to be handheld. Referring now to FIG. 2A and FIG. 2B, shown is a handheld ultrasonic measurement device 100. In some embodiments, ultrasonic measurement device 100 comprises a first frame portion 201 having an inner side and an outer side and a second frame portion 202 having an inner side and an outer side and movably connected to the frame portion 201, a first ultrasonic transducer 205A positioned on the inner side of first frame portion 201, and a second ultrasonic transducer 205B positioned on the inner side of second frame portion 202.

In some embodiments, the first ultrasonic transducer 205A is positioned on the inner side of a first end 203 of the first frame portion 201. In some embodiments, a second ultrasonic transducer 205B is positioned on the inner side of the first end 203 of second frame portion 202. In some embodiments, the first frame portion 201 further comprises a handle portion 211 at a second end 204. In some embodiments, the second frame portion 202 further comprises a second handle portion 211 at a second end 204. In some embodiments, the frame portions 201 and 202 are moveably connected such that applying a force on the handle portions 211 causes the first frame portion 201 and second frame portion 202 to separate. In some embodiments handle portions 211 may have the same shape as frame portions 201 and 202 or may have a different shape. For example, and without limitation, the handle portions 211 can be cylindrical, hemicylindrical, cuboidal, tapered, conical, or polygonal. In some embodiments, the handle portions 211 can be made of the same material as frame portions 201 and 202 or may be made of a different material. For example, and without limitation, metals, plastics, silicone, rubber, Polyethylene, Thermoplastic polyurethane (TPU), Polylactic Acid Polymer (PLA), or Polyvinyl Chloride (PVC) can be used.

In some embodiments, the linkage mechanism is a parallel linkage mechanism. In some embodiments, the parallel linkage mechanism comprises two or more supports 208 each connected to first frame portion 201 and second frame portion 202, wherein the supports are movably connected crosswise and may rotate about its connection point and/or move through a plurality of grooves positioned on the frame portions 201 and 202. The parallel linkage mechanism allows first frame portion 201 and second frame portion 202 to move in a parallel orientation relative to each other and is configured such that device 100 may be in a closed (FIG. 2A) or open state (FIG. 2B). In some embodiments, the supports 208 may comprise any material known to one of skill in the art, for example, but not limited to metals, plastics, silicone, rubber, Polyethylene, Thermoplastic polyurethane (TPU), Polylactic Acid Polymer (PLA), or Polyvinyl Chloride (PVC).

In some embodiments, device 100 further comprises a biasing mechanism. The biasing mechanism can comprise any suitable mechanism including, but not limited to, the use of tension springs, elastic connectors, and the like. In one embodiment, the biasing mechanism comprises one or more tension springs (209 and 210) connected between the first and second frame portions 201 and 202 and positioned distal and/or proximate to the parallel linkage mechanism. In some embodiments, the one or more tension springs are at a first (lower) tension when device 100 is in a closed state and the one or more tension springs are at a second (higher) tension when device 100 is in an open state, thus biasing the device 100 towards the closed state.

In some embodiments, the device 100 further comprises a force sensor 206. In some embodiments, the force sensor 106 is positioned between the second ultrasonic transducer 205B and the second frame portion 202 as depicted in FIGS. 2A and 2B. In some embodiments, the force sensor 206 can be positioned at any location on the inner surface of at least one of first frame portion 201 and second frame portion 202 and configured to measure the clamping force on a sample positioned between first and second ultrasonic transducers 205A and 205B. In some embodiments, the device 100 further comprises a displacement sensor 207 positioned between the first frame portion 201 and the second frame portion 202 and configured to measure the spacing between the first and second frame portions 201, 202, thereby determining the thickness or amount of compression of a sample positioned between the first and second ultrasonic transducer 205A and 205B.

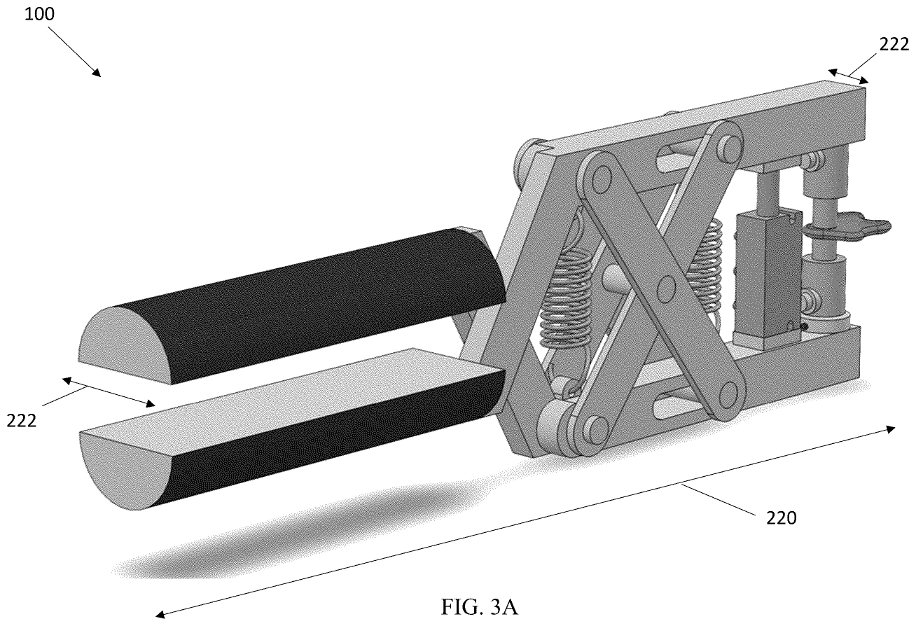

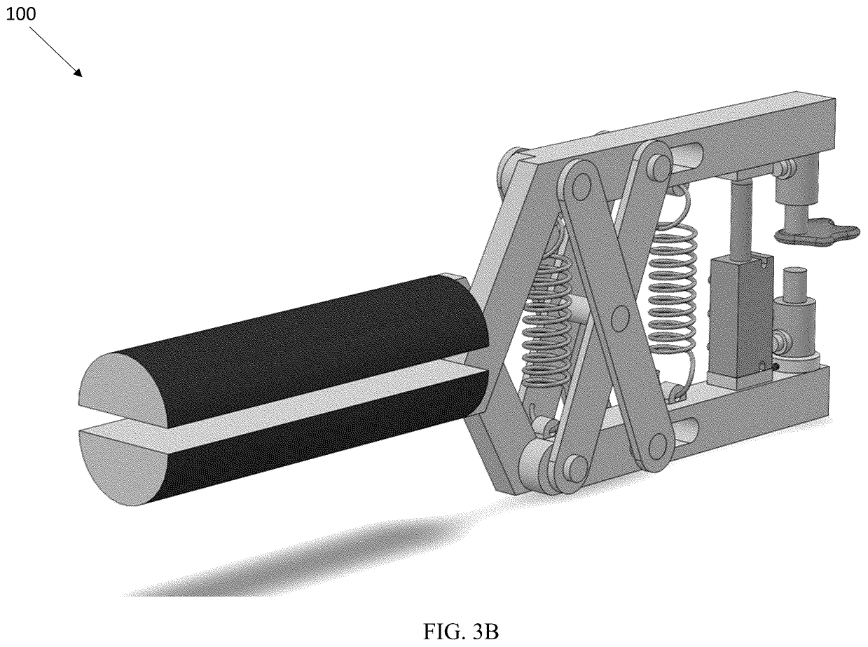

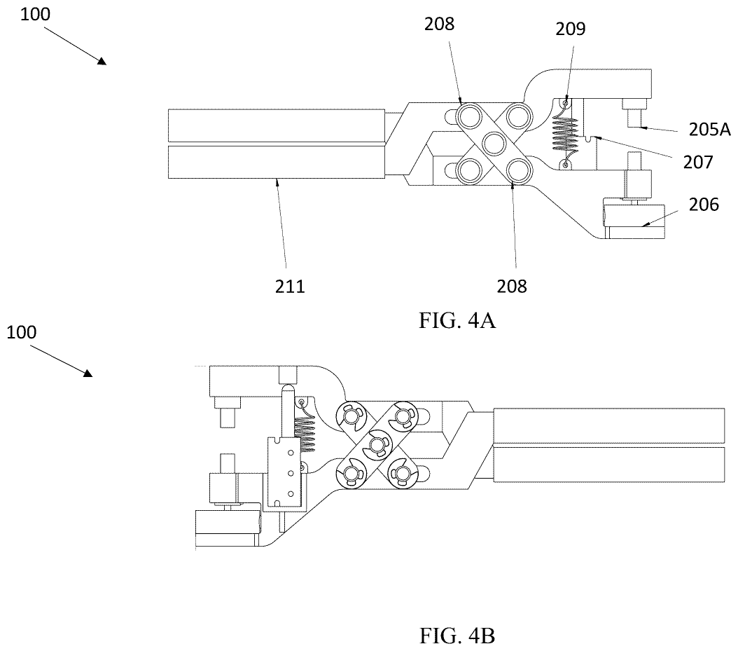

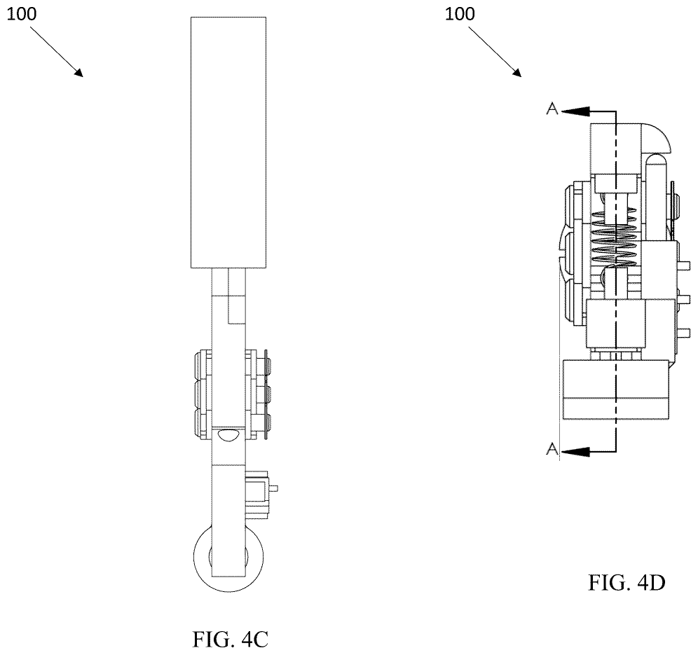

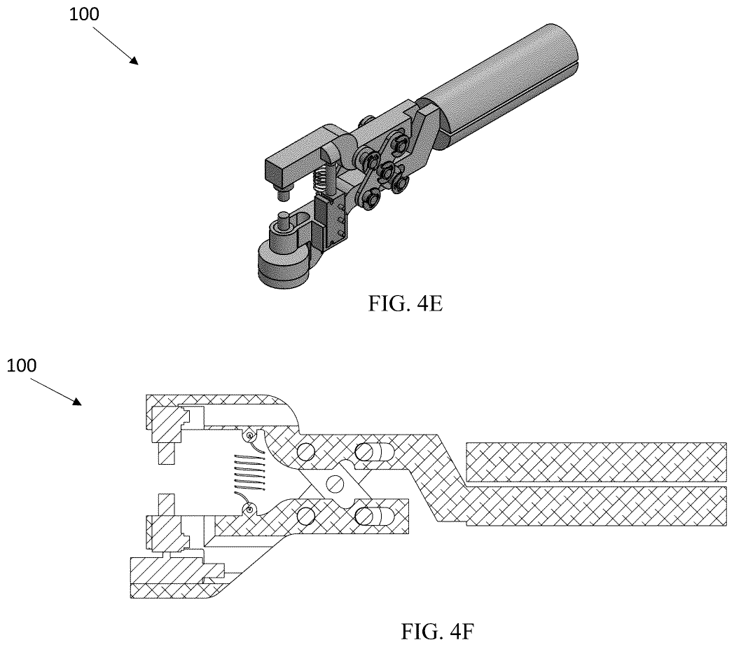

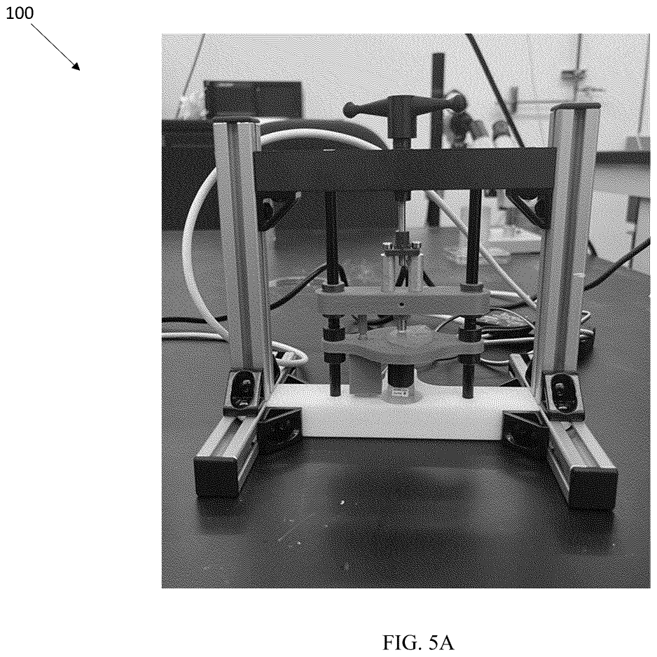

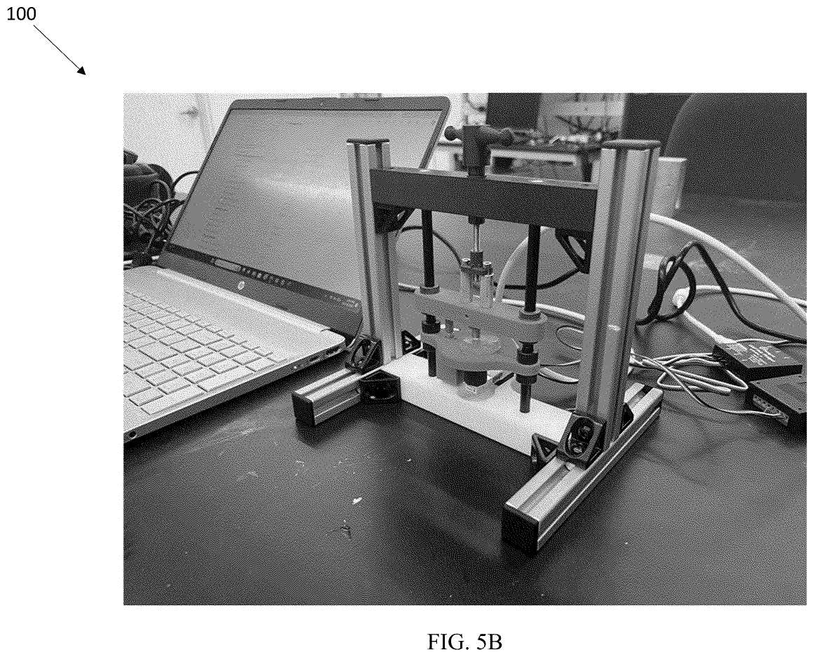

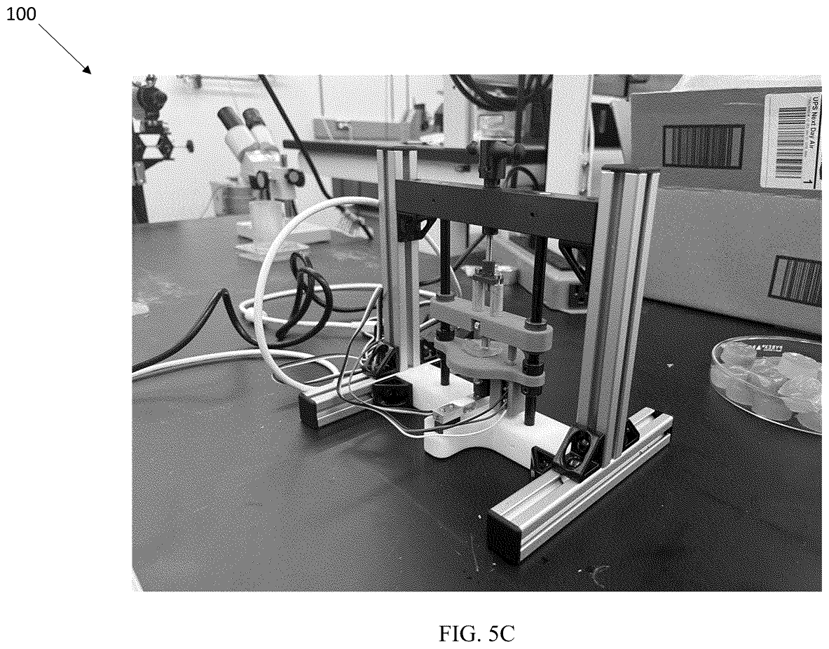

Referring now to FIG. 3A, and in some embodiments, the first and second frame portions 201 and 202 may have a length 220 of between about 10 to about 100 cm, between about 20 to about 90 cm, between about 30 to about 80 cm, between about 40 to about 70 inches, between about 45 to about 65 cm, between about 30 to about 60 cm, between about 35 to 55 cm, about 36 cm, about 37 cm, about 38 cm, about 39 cm, about 40 cm, about 41 cm, about 42 cm, about 43 cm, about 44 cm, about 45 cm, about 46 cm, about 47 cm, about 48 cm, about 49 cm, about 50 cm, about 51 cm, about 52 cm, about 53 cm, about 54 cm, or about 55 cm.

In some embodiments, the first and second frame portions 201 and 202 may have a width and/or thickness (or diameter) 222 of less than or equal to 15 cm, less than or equal to 14 cm, less than or equal to 13 cm, less than or equal to 12 cm, less than or equal to 11 cm, less than or equal to 10 cm, less than or equal to 9 cm, less than or equal to 8 cm, less than or equal to 7 cm, less than or equal to 6 cm, less than or equal to 5 cm, less than or equal to 4 cm, less than or equal to 3 cm, less than or equal to 2 cm, or less than or equal to 1 cm, or between 0.1 cm and 15 cm. In some embodiments, the thickness of the first and second portions 201 and 202 may vary across their lengths.

In some embodiments, the force sensor can comprise any suitable force sensor including, but not limited to, load cells, force sensing resistors, strain gauges, and the like. In some embodiments, the force sensor is configured to measure the force applied to a sample positioned between the first and second ultrasonic transducers. In some embodiments, the device 100 is configured to apply a force in the range of 0 grams to 50000 grams, 0 grams and 10000 grams, 0 grams and 900 grams, 0 grams and 500 grams, 0 grams and 200 grams, 0 grams and 100 grams, 0 grams and 90 grams, 0 grams and 80 grams, 0 grams and 70 grams, 0 grams and 60 grams, 0 grams and 55 grams, 0 grams and 50 grams, 0 grams and 45 grams, 0 grams and 40 grams, 0 grams and 35 grams, 0 grams and 30 grams, 0 grams and 25 grams, 0 grams and 20 grams, 0 grams and 15 grams, 0 grams and 10 grams, 0 grams and 5 grams. In some embodiments, device 100 is configured to apply a force in the range of 0 grams and 100 grams.

In some embodiments, the displacement sensor may comprise any suitable displacement sensor including, but not limited to, linear potentiometers, linear encoders, magnetostrictive linear position sensors or inductive linear position sensors. In some embodiments, displacement sensor is a linear potentiometer. In some embodiments, the displacement sensor is configured to measure the distance between the second ultrasonic transducers, and thereby the thickness of the sample sandwiched between the transducers.

In some embodiments, the device 100 is configured to have a spacing between the first ultrasonic transducer and the second ultrasonic transducer ranging between about 0 mm and 200 mm, between about 0 mm and 190 mm, between about 0 mm and 180 mm, between about 0 mm and 170 mm, between about 0 mm and 160 mm, between about 0 mm and 150 mm, between about 0 mm and 140 mm, between about 0 mm and 130 mm, between about 0 mm and 120 mm, between about 0 and 110 mm, between about 0 mm and 100 mm, between about 0 mm and 95 mm, between about 0 mm and 90 mm, between about 0 mm and 80 mm, between about 0 mm and 75 mm, between about 0 mm and 70 mm, between about 0 mm and 65 mm, between about 0 mm and 55 mm, between about 0 mm and 50 mm, between about 0 mm and 45 mm, between about 0 mm and 40 mm, between about 0 mm and 35 mm, between about 0 mm and 30 mm, or between about 0 mm and 25 mm. In some embodiments, the device is configured to have a spacing ranging between about 0 mm and 150 mm. In some embodiments, the spacing between the first ultrasonic transducer and the second ultrasonic transducer can be of any value within the range.

In some embodiments, the force sensor and the displacement sensor are configured to monitor the compressive force exerted on the sample, and the compressed thickness of the sample, thereby providing increased repeatability of the measurements and more accurate data for the proper interpretation of the resulting ultrasound measurement. In some embodiments, device 100 may comprise any other suitable sensors including, but not limited to, torque sensors, gyroscopic sensors, pressure sensors, and the like.

In some embodiments, the device 100 is part of a system for performing ultrasonic measurements on a sample. In some embodiments, the system comprises the device 100 and a computing system (e.g., computer 120) communicatively connected to the ultrasonic measurement device, further comprising a processor, a non-transitory computer-readable medium and an interface device. The non-transitory computer-readable medium contains instructions, which when executed by the processor, perform steps comprising a) measuring the displacement between the first and second ultrasonic transducers, b) measuring a force applied to the sample via the force sensor, c) performing an ultrasound measurement on the sample, and d) displaying the results of the displacement, force and ultrasound measurement. In some embodiments, the sample may be an organic material sample (e.g. a tissue sample, a cellular sample, a skin sample, an organ sample, a muscle sample), or an inorganic material sample (e.g. a metal sample, a metal alloy sample, a plastic sample, or a polymer sample).

The transducers and sensors described herein may return measurements to an interface device as digital signals, analog signals or both. As described herein, “interface device” refers to any device capable of receiving analog or digital signals and performing one or more of: storing the data on a non-transitory computer readable medium or transmitting the data via a wired or wireless communication link to a remote computing device. In some embodiments, the interface device may further include non-transitory computer-readable media having calibration data for the force sensor and displacement sensor. In some embodiments, the interface device may further comprise a processor and stored instructions for performing analysis or display of the data collected. In some embodiments, the interface device further comprises a graphical user interface (GUI) and a display capable of presenting some or all of the data, or calculated derivatives thereof, in human-readable form. The data collected may be presented as a time series graph, real-time display of current values, minimum or maximum values, or any other display format known in the art. In some embodiments, the interface device can connect to one or more external displays in a wired or wireless connection. In some embodiments, the interface device can be incorporated into a computing device including but not limited to desktop or mobile devices, laptops, desktops, tablets, smartphones or other wireless digital/cellular phones, televisions, or other thin client devices as would be understood by those skilled in the art.

In another aspect, the present invention relates to an ultrasonic measurement method, comprising the steps of a) providing an ultrasonic measurement device, b) positioning a sample between the first and second ultrasonic transducers, c) measuring the displacement between the first and second ultrasonic transducers, d) measuring a force applied to the sample via the force sensor, e) performing an ultrasound measurement on the sample, and f) displaying the results of the displacement, force, and ultrasound measurement.

In some embodiments, step b) of the method further comprises positioning a sample between the first and second frame portions and using the linkage mechanism to configure the device into a closed state, such that the first and second ultrasonic transducers are in direct contact with the sample.

In some embodiments, step b) of the method further comprises applying a squeezing force to the first and second handle portions to open the device, such that a sample can be positioned between the first and second ultrasonic transducers. The squeezing force is removed once the sample has been positioned and the device is closed.

In some embodiments, the method further comprises calibrating a displacement between the first and second ultrasound transducers and calibrating a force between the first and second ultrasound transducers.

In some aspects of the present invention, software executing the instructions provided herein may be stored on a non-transitory computer-readable medium, wherein the software performs some or all of the steps of the present invention when executed on a processor.

Aspects of the invention relate to algorithms executed in computer software. Though certain embodiments may be described as written in particular programming languages, or executed on particular operating systems or computing platforms, it is understood that the system and method of the present invention is not limited to any particular computing language, platform, or combination thereof. Software executing the algorithms described herein may be written in any programming language known in the art, compiled or interpreted, including but not limited to C, C++, C #, Objective-C, Java, JavaScript, MATLAB, Python, PHP, Perl, Ruby, or Visual Basic. It is further understood that elements of the present invention may be executed on any acceptable computing platform, including but not limited to a server, a cloud instance, a workstation, a thin client, a mobile device, an embedded microcontroller, a television, or any other suitable computing device known in the art.

Parts of this invention are described as software running on a computing device. Though software described herein may be disclosed as operating on one particular computing device (e.g. a dedicated server or a workstation), it is understood in the art that software is intrinsically portable and that most software running on a dedicated server may also be run, for the purposes of the present invention, on any of a wide range of devices including desktop or mobile devices, laptops, tablets, smartphones, watches, wearable electronics or other wireless digital/cellular phones, televisions, cloud instances, embedded microcontrollers, thin client devices, or any other suitable computing device known in the art.

Similarly, parts of this invention are described as communicating over a variety of wireless or wired computer networks. For the purposes of this invention, the words “network”, “networked”, and “networking” are understood to encompass wired Ethernet, fiber optic connections, wireless connections including any of the various 802.11 standards, cellular WAN infrastructures such as 3G, 4G/LTE, or 5G networks, Bluetooth®, Bluetooth® Low Energy (BLE) or Zigbee® communication links, or any other method by which one electronic device is capable of communicating with another. In some embodiments, elements of the networked portion of the invention may be implemented over a Virtual Private Network (VPN).

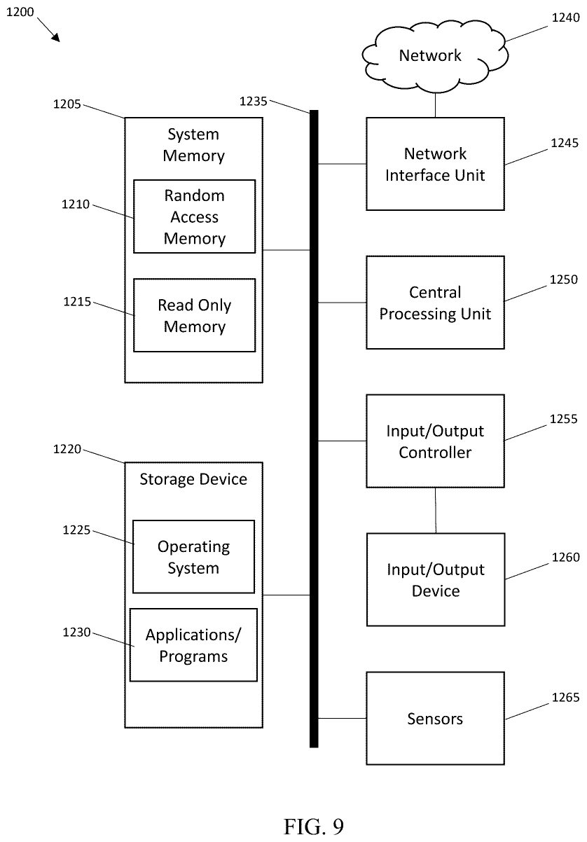

FIG. 9 and the following discussion are intended to provide a brief, general description of a suitable computing environment in which the invention may be implemented. While the invention is described above in the general context of program modules that execute in conjunction with an application program that runs on an operating system on a computer, those skilled in the art will recognize that the invention may also be implemented in combination with other program modules.

Generally, program modules include routines, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

FIG. 9 depicts an illustrative computer architecture for a computer 1200 for practicing the various embodiments of the invention. The computer architecture shown in FIG. 9 illustrates a conventional personal computer, including a central processing unit 1250 (“CPU”), a system memory 1205, including a random-access memory 1210 (“RAM”) and a read-only memory (“ROM”) 1215, and a system bus 1235 that couples the system memory 1205 to the CPU 1250. A basic input/output system containing the basic routines that help to transfer information between elements within the computer, such as during startup, is stored in the ROM 1215. The computer 1200 further includes a storage device 1220 for storing an operating system 1225, application/program 1230, and data

The storage device 1220 is connected to the CPU 1250 through a storage controller (not shown) connected to the bus 1235. The storage device 1220 and its associated computer-readable media, provide non-volatile storage for the computer 1200. Although the description of computer-readable media contained herein refers to a storage device, such as a hard disk or CD-ROM drive, it should be appreciated by those skilled in the art that computer-readable media can be any available media that can be accessed by the computer 1200.

By way of example, and not to be limiting, computer-readable media may comprise computer storage media. Computer storage media includes volatile and non-volatile, removable and non-removable media implemented in any method or technology for storage of information such as computer-readable instructions, data structures, program modules or other data. Computer storage media includes, but is not limited to, RAM, ROM, EPROM, EEPROM, flash memory or other solid state memory technology, CD-ROM, DVD, or other optical storage, magnetic cassettes, magnetic tape, magnetic disk storage or other magnetic storage devices, or any other medium which can be used to store the desired information and which can be accessed by the computer.

According to various embodiments of the invention, the computer 1200 may operate in a networked environment using logical connections to remote computers through a network 1240, such as TCP/IP network such as the Internet or an intranet. The computer 1200 may connect to the network 1240 through a network interface unit 1245 connected to the bus 1235. It should be appreciated that the network interface unit 1245 may also be utilized to connect to other types of networks and remote computer systems.

The computer 1200 may also include an input/output controller 1255 for receiving and processing input from a number of input/output devices 1260, including a keyboard, a mouse, a touchscreen, a camera, a microphone, a controller, a joystick, or other type of input device. Similarly, the input/output controller 1255 may provide output to a display screen, a printer, a speaker, or other type of output device. The computer 1200 can connect to the input/output device 1260 via a wired connection including, but not limited to, fiber optic, ethernet, or copper wire or wireless means including, but not limited to, Bluetooth, Near-Field Communication (NFC), infrared, or other suitable wired or wireless connections.

As mentioned briefly above, a number of program modules and data files may be stored in the storage device 1220 and RAM 1210 of the computer 1200, including an operating system 1225 suitable for controlling the operation of a networked computer. The storage device 1220 and RAM 1210 may also store one or more applications/programs 1230. In particular, the storage device 1220 and RAM 1210 may store an application/program 1230 for providing a variety of functionalities to a user. For instance, the application/program 1230 may comprise many types of programs such as a word processing application, a spreadsheet application, a desktop publishing application, a database application, a gaming application, internet browsing application, electronic mail application, messaging application, and the like. According to an embodiment of the present invention, the application/program 1230 comprises a multiple functionality software application for providing word processing functionality, slide presentation functionality, spreadsheet functionality, database functionality and the like.

The computer 1200 in some embodiments can include a variety of sensors 1265 for monitoring the environment surrounding and the environment internal to the computer 1200. These sensors 1265 can include a Global Positioning System (GPS) sensor, a photosensitive sensor, a gyroscope, a magnetometer, thermometer, a proximity sensor, an accelerometer, a microphone, biometric sensor, barometer, humidity sensor, radiation sensor, or any other suitable sensor.

### EXPERIMENTAL EXAMPLES

The invention is further described in detail by reference to the following experimental examples. These examples are provided for purposes of illustration only, and are not intended to be limiting unless otherwise specified. Thus, the invention should in no way be construed as being limited to the following examples, but rather, should be construed to encompass any and all variations which become evident as a result of the teaching provided herein.

Without further description, it is believed that one of ordinary skill in the art can, using the preceding description and the following illustrative examples, make and utilize the present invention and practice the claimed methods. The following working examples therefore are not to be construed as limiting in any way the remainder of the disclosure.

### Example 1: Effect of Clamping Force on Peak Density

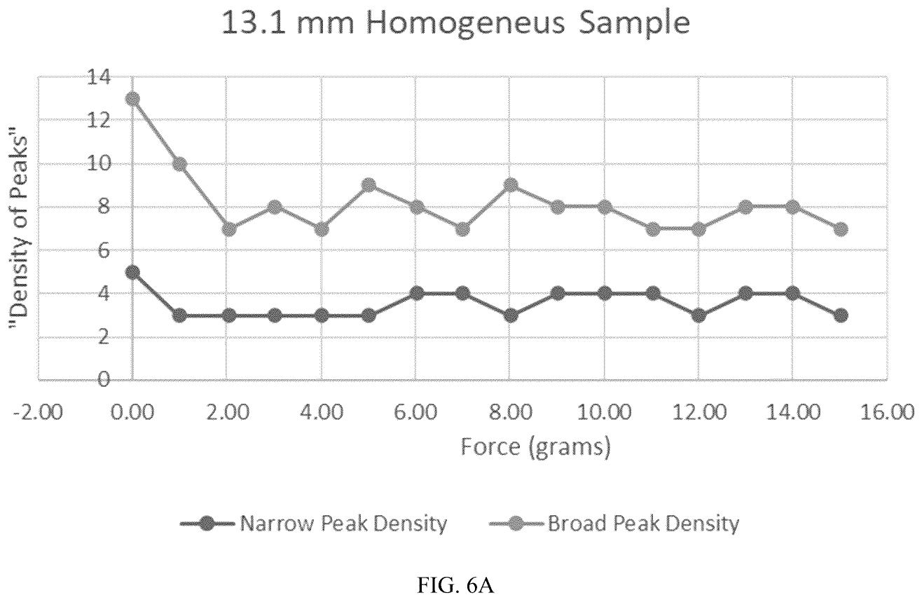

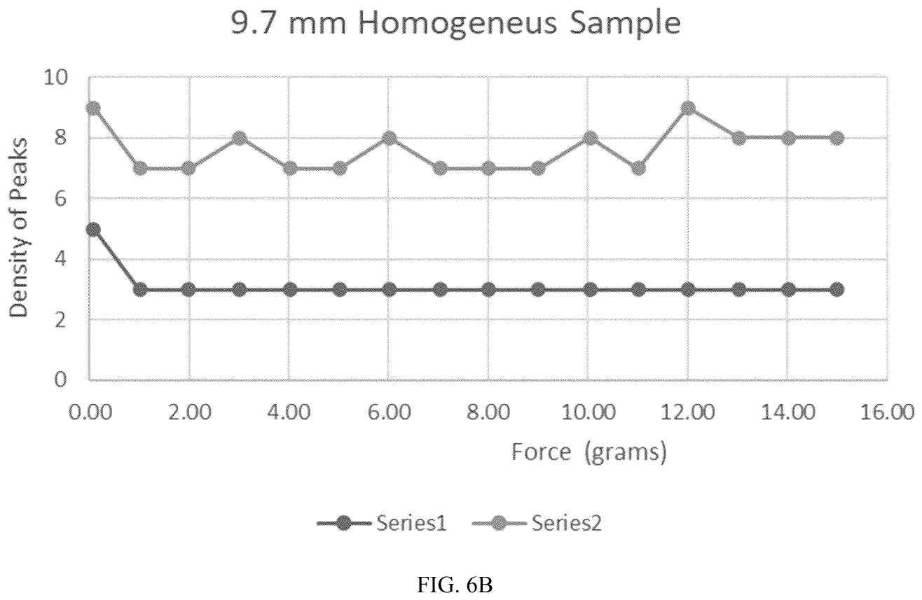

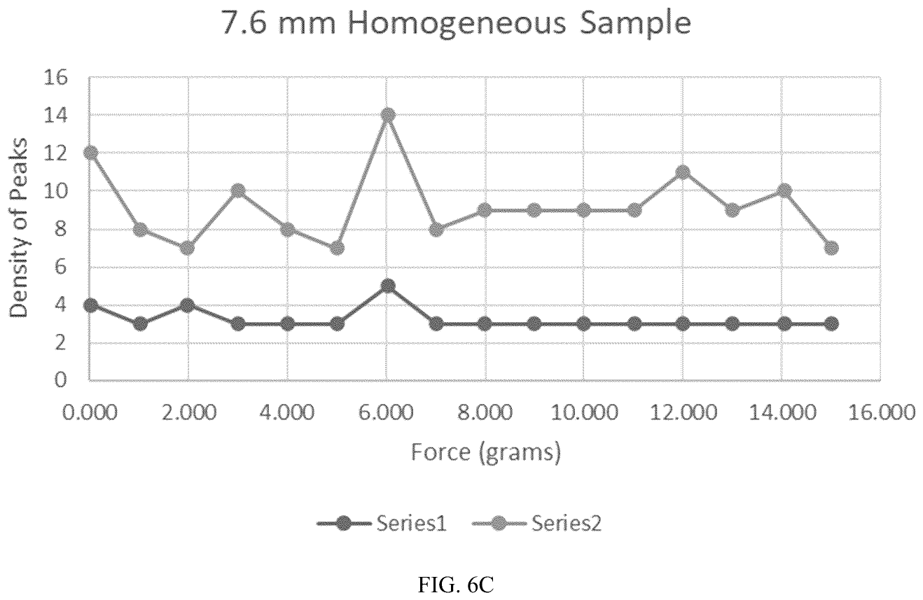

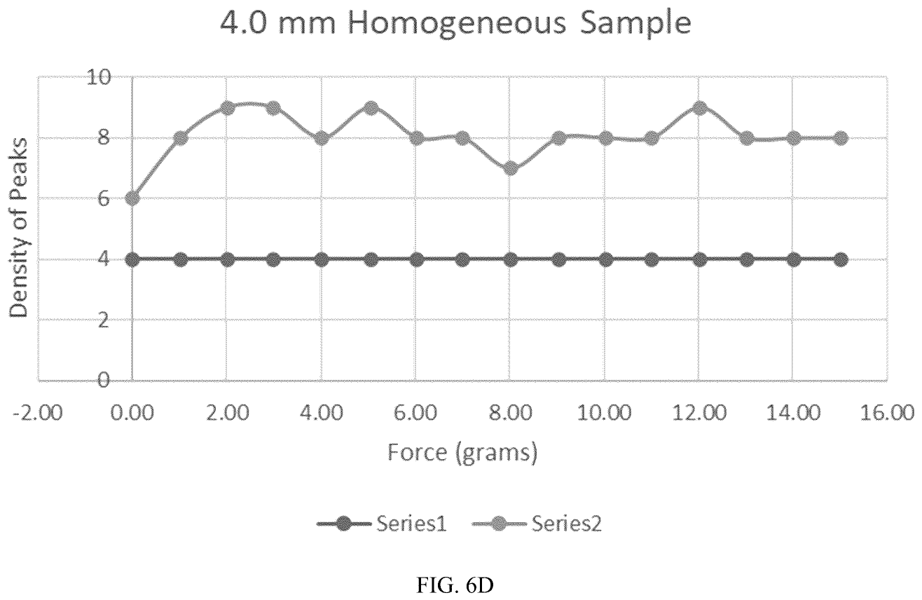

Experiments were performed on four individual gelatin-based tissue phantoms of different thicknesses ranging from 4 to 13 millimeters. A transmission (or “pitch-catch” ultrasound waveform was recorded for 16 values of force applied to each sample from 0-15 grams of force in increments of 1 gram force. Continuous logs of the outputs from both the force and displacement sensors were recorded. The force and thickness measurements for each of the 64 waveforms were extracted using the synchronized timestamps. FIGS. 6A, 6B, 6C, and 6D depict the variation of an ultrasound characteristic, “density of peaks” with the compressive force applied to the sample by the heads of the ultrasonic transducers. The density of peaks is dependent on the bandwidth of frequencies included in its calculation. Results for a narrow bandwidth from 12-24 MHz (centered on the 18 MHz nominal frequency of the transducers) are shown in blue, while peak density values for a 0-30 MHz bandwidth are shown in orange.

### Example 2: Effect of Clamping Force on Sample Thickness

The effect of clamping force on compressed tissue thickness on four individual gelatin-based tissue phantoms of different thicknesses was studied.

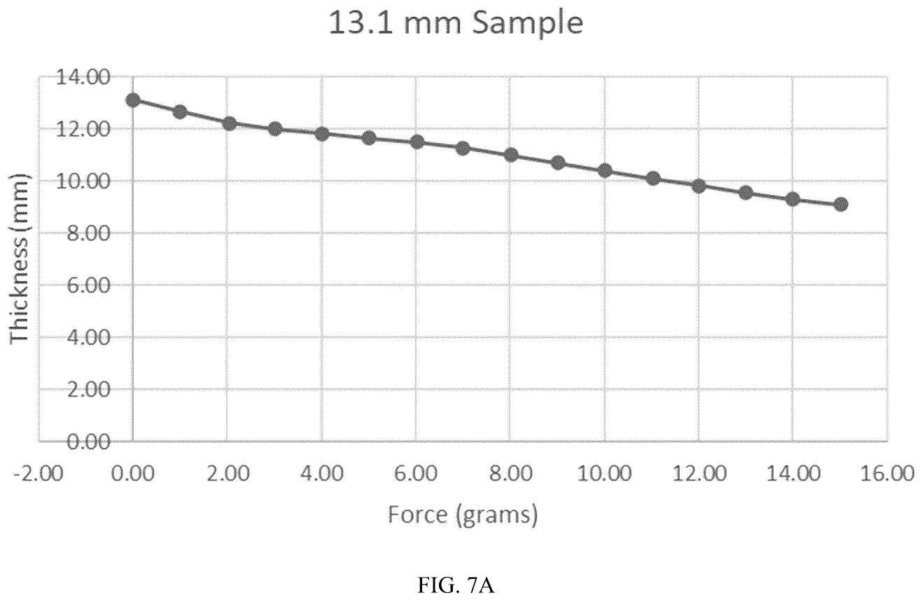

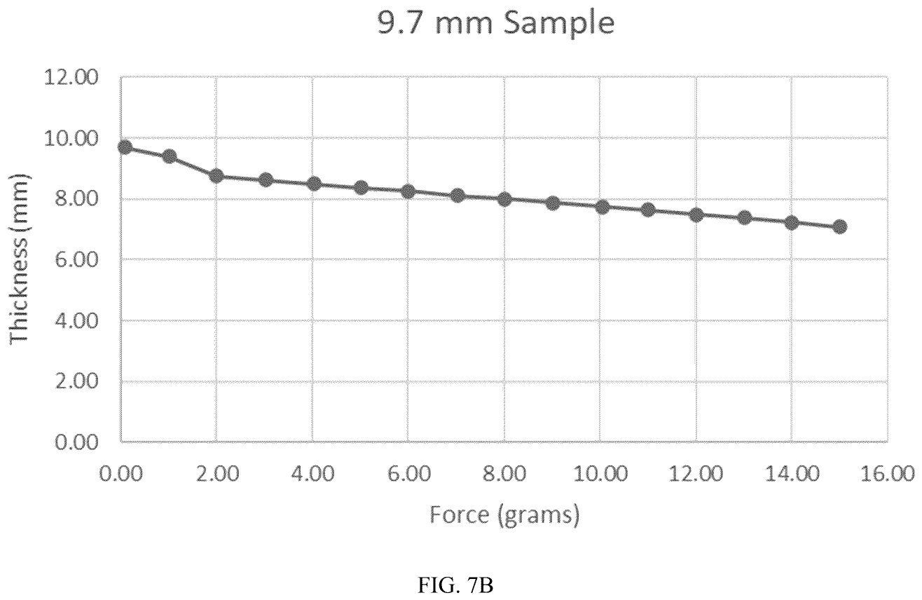

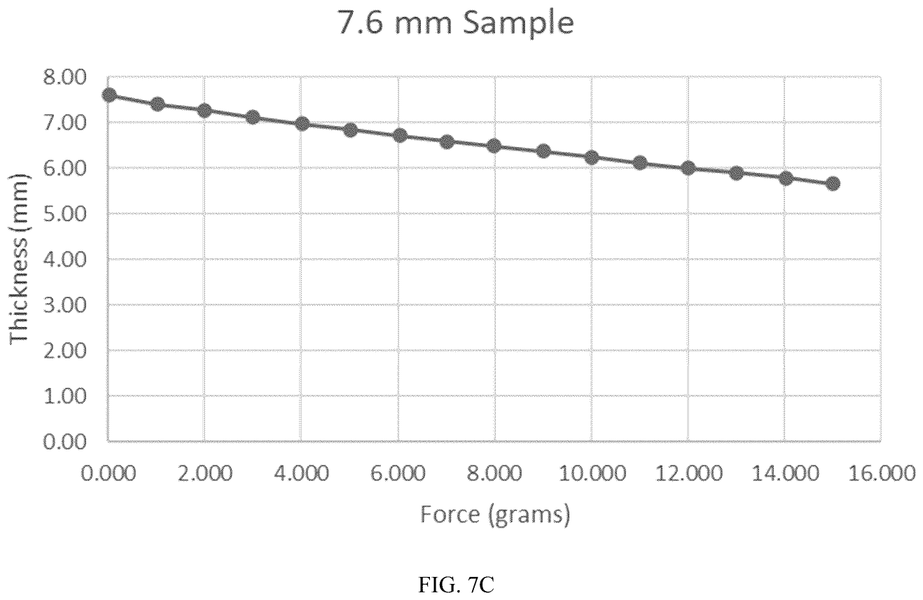

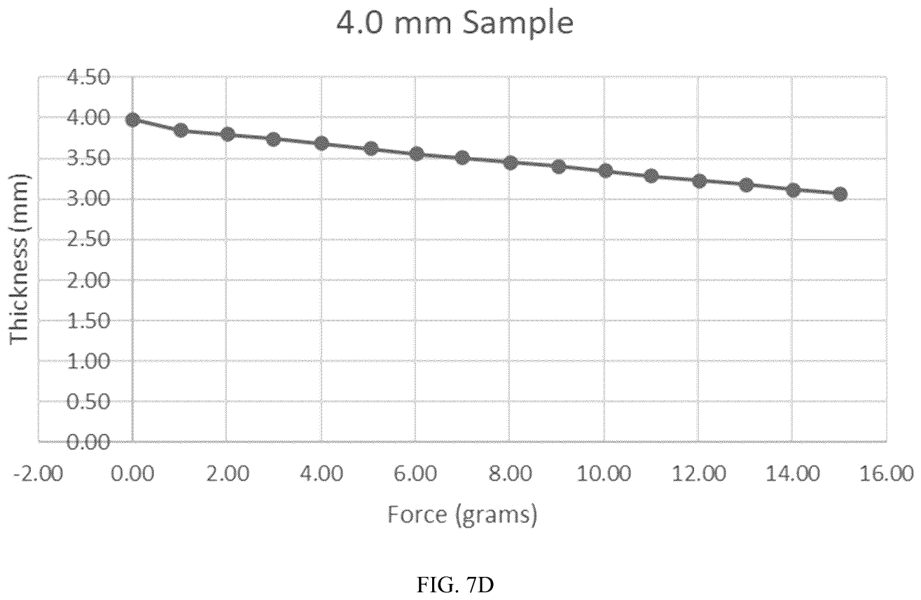

FIG. 7A depicts a graph showing the results of the experiment for a tissue sample of 13.1 mm original thickness. FIG. 7B depicts a graph showing the results of the experiment for a tissue sample of 9.7 mm original thickness. FIG. 7C depicts a graph showing the results of the experiment for a tissue sample of 7.6 mm original thickness. FIG. 7D depicts a graph showing the results of the experiment for a tissue sample of 4.0 mm original thickness.

### Example 3: Effect of Compressed Sample Thickness on Broad-band Peak Density

Experiments were performed on four individual gelatin-based tissue phantoms of different thicknesses ranging from 4 to 13 millimeters.

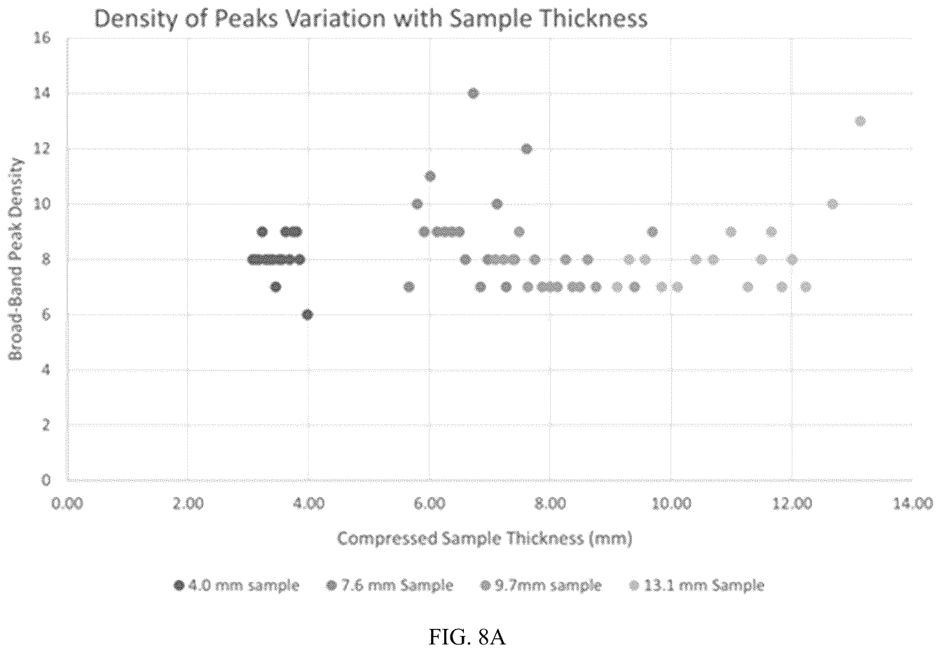

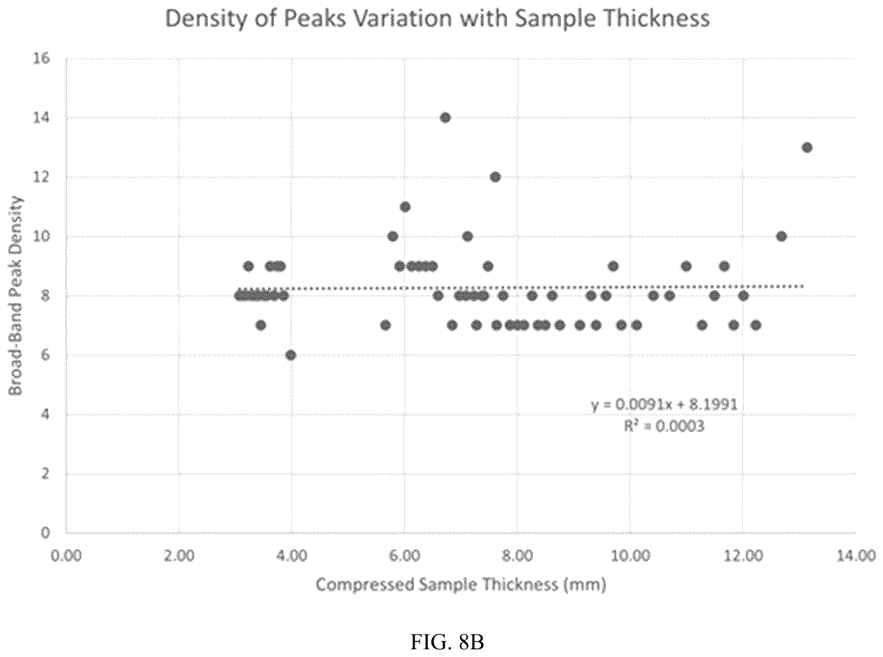

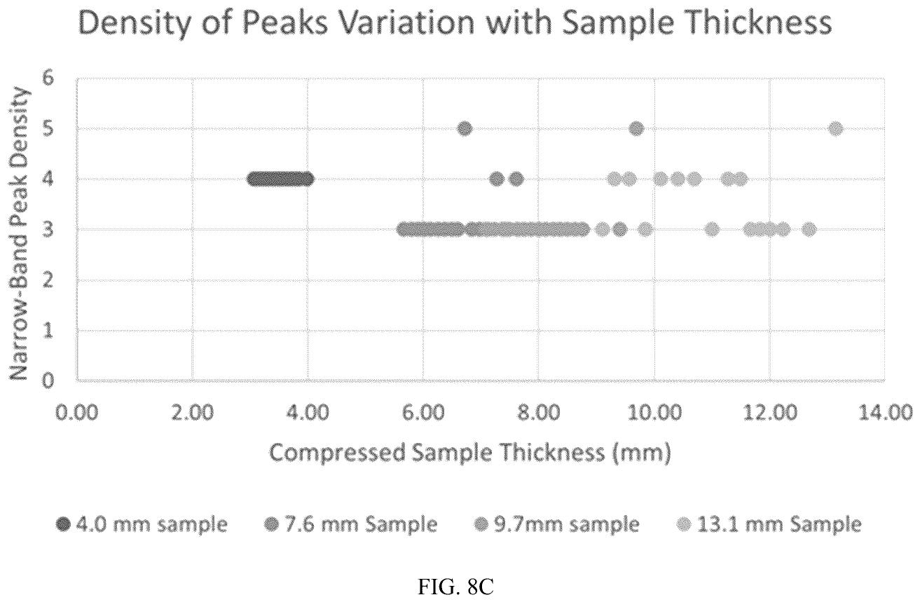

FIG. 8A and FIG. 8B depict graphs showing the results of the effect of compressed sample thickness on broad-band peak density calculated from the 0-30 MHz bandwidth. FIG. 8C depicts a graph showing the results of the effect of compressed sample thickness on narrow-band peak density calculated from the 12-24 MHz bandwidth.

The disclosures of each and every patent, patent application, and publication cited herein are hereby each incorporated herein by reference in their entirety. While this invention has been disclosed with reference to specific embodiments, it is apparent that other embodiments and variations of this invention may be devised by others skilled in the art without departing from the true spirit and scope of the invention. The appended claims are intended to be construed to include all such embodiments and equivalent variations.

What is claimed is:

1. An ultrasonic measurement device comprising:
a first frame portion with an inner side and an outer side;
a second frame portion with an inner side and an outer side;
wherein the first frame portion and the second frame portion are movably connected, wherein the first portion is configured to move in a parallel orientation relative to the second portion;
a first ultrasonic transducer positioned on the inner side of the first frame portion; and
a second ultrasonic transducer positioned on the inner side of the second frame portion opposite the first transducer.

2. The device of claim 1, wherein the first and second frame portions are movably connected via a pivot, a hinge, screw jack mechanism, or a parallel linkage mechanism.

3. The device of claim 1, wherein the first ultrasonic transducer is configured to emit or receive an ultrasonic signal.

4. The device of claim 1, wherein the second ultrasonic transducer is configured to emit or receive an ultrasonic signal.

5. The ultrasonic device of claim 1, further comprising a force sensor connected to at least one of the first and second frame portions and configured to measure a clamping force exerted between the first and second ultrasonic transducers.

6. The device of claim 5, wherein the force sensor comprises at least one of a load cell and a force sensing resistor.

7. The device of claim 1, further comprising a displacement sensor connected to at least one of the first and second frame portions and configured to measure a spacing between the first and second ultrasonic transducers.

8. The device of claim 7, wherein the displacement sensor comprises a linear potentiometer.

9. The device of claim 1, wherein the ultrasonic measurement device is configured as a handheld device.

10. The device of claim 1, wherein the first ultrasonic transducer is positioned at a first end of the first frame portion, and the second ultrasonic transducers is positioned at a first end of the second frame portion.

11. The device of claim 1, wherein the first frame portion further comprises a first handle portion at a second end, and the second frame portion further comprises a second handle portion at a second end.

12. The device of claim 11, wherein a force applied to the first and second handle portions causes the first ends of the first and second frame portions to separate.

13. The device of claim 1, further comprising a biasing mechanism configured to bias the device closed.

14. The device of claim 13, wherein the biasing mechanism comprises one or more tension springs mounted between the first and second frame portions at locations proximate to the linkage point.

15. The device of claim 1, wherein the device is configured to apply a force in the range of 0 to 100 grams to a sample.

16. The device of claim 1, wherein the device is configured to have a spacing of 0 to 150 mm between the first and second ultrasonic transducers.

17. The device of claim 1, further comprising a computing system communicatively connected to the device, comprising a processor and a non-transitory computer-readable medium with instructions stored thereon, which when executed by the processor, perform steps comprising:
measuring the displacement between the first and second ultrasonic transducers;
measuring a force applied to the sample via the force sensor;
performing an ultrasound measurement on the sample; and
displaying the results of the displacement, force, and ultrasound measurement.

18. An ultrasonic measurement method, comprising:
providing the ultrasonic measurement device of claim 1;
positioning a sample between the first and second ultrasonic transducers;
measuring the displacement between the first and second ultrasonic transducers;
measuring a force applied to the sample via the force sensor;
performing an ultrasound measurement on the sample; and
displaying results of the displacement, force and ultrasound measurement.

19. The method of claim 18, further comprising:
applying a squeezing force to the first and second handle portions; and
removing the squeezing force when the sample is positioned between the first and second ultrasonic transducers.

20. The method of claim 18, further comprising:
calibrating a displacement between the first and second ultrasonic transducers; and
calibrating a force between the first and second ultrasonic transducers.
